(19) United States
(12) Patent Application Publication
(10) Pub. No.: US 2006/0068989 A1
(43) Pub. Date: Mar. 30, 2006

(54) Carbon-intersticed metallic palladium, palladium catalyst and method for preparation thereof, and method for producing alpha,beta-unsaturated carboxylic acid

(75) Inventors: Wataru Ninomiya, Hiroshima (JP); Yuji Fujimori, Hiroshima (JP); Akio Takeda, Hiroshima (JP); Seiichi Kawato, Hiroshima (JP); Jinko Izumi, Aichi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Mitsubishi Rayon co., Ltd., Tokyo (JP)

(21) Appl. No.: 10/531,252

(22) PCT Filed: Oct. 27, 2003
(86) PCT No.: PCT/JP03/13708

§ 371 Date: Apr. 12, 2005

(30) Foreign Application Priority Data
Oct. 28, 2002 (JP) 2002-312493

(51) Int. Cl. B01J 23/44

(52) U.S. Cl. 502/339; 75/741

(57) ABSTRACT

A carbon-insertion-type palladium metal in which an amount of inserted carbon is 0.16 mol or more with respect to 1.0 mol of a palladium metal, and a carbon-insertion-type palladium metal in which a crystal face distance of a (111) face of a palladium metal is 2.270 Å or more are useful as raw materials of a palladium catalyst for use in an α,β-unsaturated carboxylic acid preparation reaction, and the like. The carbon-insertion-type palladium metal can preferably be prepared by reduction of palladium in a palladium compound having a chlorine content of 0 to 300 ppm.

### TECHNICAL FIELD

The present invention relates to a carbon-insertion-type palladium metal, a palladium catalyst containing the carbon-insertion-type palladium metal for preparation of an α,β-unsaturated carboxylic acid or the like, a preparation method of the carbon-insertion-type palladium metal, a preparation method of the palladium catalyst, and a preparation method of the α,β-unsaturated carboxylic acid by use of the palladium metal.

### BACKGROUND ART

According to a database JCPDS of an XRD pattern, a crystal face distance of a (111) face of a general palladium zero-valent metal is 2.246 Å (diffraction angle; 2θ=40.12°).

It is known that carbon inserts into a palladium metal depending on a preparation method and conditions, and the like. For example, it is described in J. Am. Chem. Soc., 107 (1985), p. 4547-4548 that the carbon insertion into palladium black occurs by an interaction with ethylene, acetylene, and carbon monoxide in a gaseous phase. In J. Phys. Chem. B, 101 (1997), p. 5470-5472, a preparation method of carbon-insertion-type palladium nano-particles in an aqueous solution by ultrasonic irradiation is described. However, an amount of inserted carbon in a carbon-insertion-type palladium metal prepared by these methods is 0.15 mol or less with respect to 1.0 mol of the palladium metal. In these methods, the carbon-insertion-type palladium metal is prepared by strict preparation conditions such as a high-temperature treatment at 200° C. or more and irradiation with a high-output ultrasonic wave.

On the other hand, it is known that the palladium metal is usable as catalysts of various reactions. For example, in Japanese Patent Application Laid-Open Nos. 60-139341, 60-139643, and 60-155148, a method is described in which an olefin or α,β-unsaturated aldehyde is oxidized with molecular oxygen in a liquid phase under the presence of a palladium catalyst including the palladium metal to prepare an α,β-unsaturated carboxylic acid and the palladium catalyst can be prepared by reduction of a palladium compound with an olefin having 3 to 6 carbon atoms.

Moreover, in Industrial Chemical Journal, Vol. 74, No. 4 (1971), p. 134-139, a method is described in which a palladium black catalyst prepared from an aqueous palladium chloride solution is used to perform a liquid-phase oxidation reaction of propylene in water. In Catalysis Today, 3 (1988), p. 245-258, a method is described in which an activated carbon-supported palladium catalyst is used to selectively oxidize propylene, 1-butene, 2-butene, and isobutylene. In Japanese Patent Application Laid-Open No. 56-59722, a method is described in which an aqueous solution of a molybdenum compound and the palladium catalyst are used and an olefin is oxidized with molecular oxygen in a liquid phase to prepare an α,β-unsaturated aldehyde and α,β-unsaturated carboxylic acid, and it is also described that palladium chloride, palladium acetate, and palladium oxide can be used as raw materials of the palladium catalyst.

According to the present inventors' studies, palladium compounds such as palladium chloride and palladium acetate which are the raw materials of the palladium catalyst contain chlorine in an amount usually exceeding 300 ppm. An amount of inserted carbon in the palladium metal prepared using the palladium compounds is substantially 0, and a crystal face distance of a (111) face of the palladium metal is about 2.246 Å.

Moreover, in WO 02/083299, a method is described in which acrylic acid and methacrylic acid are prepared using a substantially amorphous palladium metal catalyst, and in the catalyst, a d-value of an X-ray diffraction pattern prepared by reduction of palladium acetate is about 2.30 Å. The present inventors additionally tested an example of this document, and many polymers or oligomers which had not been considered in calculation of a reaction performance were formed. Considering these formation amounts, the reaction performance described in paragraphs of the example of the document becomes much lower.

<Prior Document List>

Japanese Patent Application Laid-Open No. 60-139341
Japanese Patent Application Laid-Open No. 60-139643
Japanese Patent Application Laid-Open No. 60-155148
Japanese Patent Application Laid-Open No. 56-59722
J. Am. Chem. Soc., 107 (1985), p. 4547-4548
J. Phys. Chem. B, 101 (1997), p. 5470-5472
Industrial Chemical Journal Vol. 74 No. 4 (1971), p. 134-139
Catalysis Today, 3 (1988), p. 245-258
WO 02/083299

### DISCLOSURE OF THE INVENTION

Palladium catalysts disclosed in the above-described documents are insufficient in reaction performances in cases where they have been used in various reactions, especially in a reaction in which an olefin or α,β-unsaturated aldehyde is oxidized with molecular oxygen in a liquid phase to prepare an α,β-unsaturated carboxylic acid.

An object of the present invention is to provide a carbon-insertion-type palladium metal which is useful as a palladium catalyst constituting a catalyst for various reactions such as an α,β-unsaturated carboxylic acid preparation reaction, a palladium catalyst containing the carbon-insertion-type palladium metal for preparation of an α,β-unsaturated carboxylic acid or the like, a preparation method of them, and a preparation method of the α,β-unsaturated carboxylic acid by use of the palladium catalyst.

That is, according to the present invention, there is provided a carbon-insertion-type palladium metal in which an amount of inserted carbon is 0.16 mol or more with respect to 1.0 mol of the palladium metal. There is also provided a carbon-insertion-type palladium metal in which a crystal face distance of a (111) face of the palladium metal calculated from a diffraction angle measured by an X-ray diffraction analysis is 2.270 Å or more.

According to the present invention, there is provided a palladium catalyst containing the carbon-insertion-type palladium metal, particularly a palladium catalyst for preparation of an α,β-unsaturated carboxylic acid.

According to the present invention, there is provided a preparation method of a carbon-insertion-type palladium metal, including a step of reducing palladium in a palladium compound in a palladium compound solution in which the palladium compound having a chlorine content of 0 to 300 ppm is dissolved in a solvent.

In the preparation method of the carbon-insertion-type palladium metal, the step is preferably performed at −5 to 150° C. The solvent is preferably an organic solvent or a mixed solvent of water and an organic solvent. The organic solvent preferably contains at least one selected from a group consisting of carboxylic acids, ketones, and alcohols.

In the preparation method of the carbon-insertion-type palladium metal, reduction in the step is preferably performed by a reducing agent. The reducing agent is more preferably an olefin having 2 to 6 carbon atoms.

The preparation method of the carbon-insertion-type palladium metal is preferable as a method of preparing a carbon-insertion-type palladium metal of the present invention defined as described above.

According to the present invention, there is provided a preparation method of a palladium catalyst including the above-described preparation method of a carbon-insertion-type palladium metal.

According to the present invention, there is provided a preparation method of an α,β-unsaturated carboxylic acid in which an oxidation reaction of an olefin or α,β-unsaturated aldehyde with molecular oxygen in a liquid phase to prepare an α,β-unsaturated carboxylic acid is performed in the presence of the above-described palladium catalyst for the preparation of the α,β-unsaturated carboxylic acid.

The carbon-insertion-type palladium metal of the present invention is useful as a palladium catalyst which is a catalyst for various reactions, and is useful especially as a palladium catalyst for the preparation of an α,β-unsaturated carboxylic acid. According to the preparation method of the carbon-insertion-type palladium metal and palladium catalyst of the present invention, the above-described carbon-insertion-type palladium metal and palladium catalyst can be prepared. Furthermore, when an olefin or α,β-unsaturated aldehyde is oxidized with molecular oxygen in a liquid phase in the presence of the palladium catalyst containing the carbon-insertion-type palladium metal, the α,β-unsaturated carboxylic acid can be prepared with a high yield.

### BRIEF DESCRIPTION OF THE DRAWINGS

FIG. 1 is an X-ray diffraction analysis chart of a carbon-insertion-type palladium metal prepared in Example 1;

FIG. 2 is an X-ray diffraction analysis chart of the carbon-insertion-type palladium metal prepared in Example 2;

FIG. 3 is an X-ray diffraction analysis chart of the palladium metal prepared in Comparative Example 1; and

FIG. 4 is an X-ray diffraction analysis chart of the palladium metal prepared in Comparative Example 2.

### BEST MODE FOR CARRYING OUT THE INVENTION

A carbon-insertion-type palladium metal of the present invention is a carbon-insertion-type palladium metal having an amount of inserted carbon of 0.16 mol or more with respect to 1.0 mol of the palladium metal. The amount of inserted carbon is preferably 0.19 mol or more, more preferably 0.22 mol or more, especially preferably 0.25 mol or more. Moreover, the amount of inserted carbon is preferably 0.81 mol or less, more preferably 0.78 mol or less, especially preferably 0.75 mol or less. It is to be noted that the amount of inserted carbon can be obtained by quantifying carbon in the carbon-insertion-type palladium metal by elemental analysis.

Additionally, it is observed by an X-ray diffraction analysis (XRD) that a crystal face distance of a (111) face of a palladium metal spreads, when carbon inserts into the palladium metal. Supposedly, this is because when the amount of inserted carbon into the palladium metal increases, a ratio of a portion having a spread crystal face distance of the (111) face of the palladium metal increases. That is, for the carbon-insertion-type palladium metal of the present invention, the crystal face distance of the (111) face of the palladium metal calculated from a diffraction angle measured by the X-ray diffraction analysis is 2.270 Å or more (diffraction angle; 2θ≦39.68°). The crystal face distance is preferably 2.272 Å or more (diffraction angle; 2θ≦39.64°). Moreover, the crystal face distance is 2.290 Å or less (diffraction angle; 2θ≧39.32°). It is to be noted that the diffraction angle corresponding to the crystal face distance of the (111) face of the palladium metal measured by XRD measurement is usually observed as 38.9 to 40.2°. When two or more diffraction angles measured by the XRD measurement are observed in this range, the crystal face distance of the (111) face of the palladium metal calculated from a smallest diffraction angle may satisfy the above-described conditions.

A preparation method of the above-described carbon-insertion-type palladium metal of the present invention is not especially limited, but examples of the method include a method of reduction of palladium in a palladium compound in a palladium compound solution in which the palladium compound is dissolved in a solvent, a method of thermal treatment of the palladium compound such as a powder, a method such as a thermal treatment of palladium in an oxidized state. Above all, from the viewpoint of ease of preparing the catalyst and reproducibility, a method of reduction of palladium in the palladium compound in the palladium compound solution in which the palladium compound is dissolved in the solvent is preferable. This method will hereinafter be described in detail.

The palladium compound preferably has a chlorine content of 0 to 300 ppm. When the chlorine content is lower, the targeted crystal face distance of the (111) face of the palladium metal tends to spread. An upper limit of the chlorine content is more preferably 200 ppm or less, further preferably 150 ppm or less, especially preferably 100 ppm or less. A lower limit of the chlorine content is more preferably 10 ppm or more, further preferably 20 ppm or more, especially preferably 30 ppm or more. Examples of the palladium compound include palladium salts such as palladium acetate, palladium nitrate, and bis(acetylacetonate)palladium, palladium oxides such as palladium oxide, and the like. Above all, from the viewpoint of solubility into the solvent and ease of pyrolysis, the palladium salts are preferable, and palladium acetate is especially preferable. Additionally, since the chlorine content of the palladium compound having a commercially available industrial grade usually exceeds 300 ppm, preferably the chlorine content should be considered in selecting the palladium compound. A commercially available palladium compound having a high chlorine content may be treated by activated carbon adsorption or the like to reduce the chlorine content, and may also be used.

In a preparation method of the carbon-insertion-type palladium metal of the present invention by the use of the palladium compound having the small chlorine content, the above-described carbon-insertion-ype palladium metal can preferably be prepared. It is to be noted that the carbon-insertion-type palladium metal having a desired amount of inserted carbon can be prepared by appropriate selection of the chlorine content of the palladium compound and preparation conditions (chlorine content of the solvent, and the like).

Examples of the solvent in which the palladium compound is dissolved include water; organic solvents such as carboxylic acids, ketones, esters, and alcohols; a mixed solvent of water and organic solvent; and the like. Above all, the organic solvents or the mixed solvent of water and organic solvent are preferable.

The organic solvent preferably contains at least one selected from a group consisting of the carboxylic acids, ketones, and alcohols, more preferably contains at least one selected from a group consisting of carboxylic acids having 2 to 6 carbon atoms, ketones having 3 to 6 carbon atoms, and tertiary butanol, and especially preferably contains the carboxylic acids having 2 to 6 carbon atoms. The carboxylic acids having 2 to 6 carbon atoms is preferably at least one selected from a group consisting of acetic acid, propionic acid, n-butyric acid, n-valeric acid, and iso-valeric acid. Above all, n-valeric acid is especially preferable. The examples of the ketones having 3 to 6 carbon atoms include acetone, methyl ethyl ketone, methyl isobutyl ketone, and the like. The organic solvent may appropriately be selected in consideration of the solubility of the palladium salt.

For the mixed solvent of water and organic solvent, a mixed solvent of water and the above-described organic solvent is preferable. The mixed solvent preferably has a homogeneous state, but may also have a heterogeneous state. The amount of water in the mixed solvent is not especially limited, and the amount may also be arbitrary, but 1 wt % or more is preferable, 2 wt % or more is more preferable, 4 wt % or more is further preferable, 8 wt % or more is especially preferable, and 10 wt % or more is most preferable with respect to a total mass of water and organic solvent. The amount of water in the mixed solvent is preferably 60 wt % or less, more preferably 50 wt % or less, further preferably 40 wt % or less, especially preferably 30 wt % or less, and most preferably 20 wt % or less with respect to the total mass of water and organic solvent.

When the targeted carbon-insertion-type palladium metal contains a metal other than palladium, a method in which the metal compound of the metal is dissolved beforehand in the palladium compound solution can be used. From the viewpoint of catalyst activity of the palladium catalyst containing the carbon-insertion-type palladium metal, the content of the metal other than palladium in the carbon-insertion-type palladium metal is preferably 50 atom % or less. A smaller content of a chlorine compound contained in the metal compound of the metal other than palladium is more preferable.

A palladium compound concentration in the palladium compound solution is not especially limited, but is preferably 0.2 wt % or more, and more preferably 0.5 wt % or more. The palladium compound concentration is preferably 10 wt % or less, more preferably 4 wt % or less. A chlorine concentration in the palladium compound solution is preferably 5 ppm or less, more preferably 3 ppm or less.

Palladium in the palladium compound can be reduced with various types of reducing agents. The reducing agent is not especially limited, and the examples include hydrazine, formalin, sodium borohydride, hydrogen, formic acid, salt of formic acid, ethylene, propylene, 1-butene, 2-butene, isobutylene, 1,3-butadiene, 1-heptene, 2-heptene, 1-hexene, 2-hexene, cyclohexene, allyl alcohol, methallyl alcohol, acrolein, methacrolein, and the like. As the reducing agent, olefins having 2 to 6 carbon atoms are preferable, and the agent is more preferably at least one selected from a group consisting of propylene, isobutylene, 1-butene, and 2-butene.

When the reducing agent is a gas, palladium in the palladium compound is preferably reduced in a pressurizing device such as an autoclave. In this case, the inside of the pressurizing device is pressurized with the reducing agent. The pressure is usually 0.1 to 1.0 MPa (gauge pressure).

Moreover, when the reducing agent is a liquid or a solid, the device for the reduction of palladium is not limited, and the reducing agent may be added into the palladium compound solution. A usage of the reducing agent at this time is not especially limited, and is usually about 1 to 50 mol with respect to 1 mol of the palladium compound.

A temperature at the time of the reduction of palladium is not especially limited, but a lower limit is preferably −5° C. or more, more preferably 0° C. or more, further preferably 10° C. or more, and especially preferably 15° C. or more. An upper limit of a reduction temperature is preferably 150° C. or less, more preferably 50° C. or less, further preferably 45° C. or less, especially preferably 40° C. or less.

When palladium in the palladium compound is reduced by this method, a palladium zero-valent metal is deposited in the palladium compound solution. Carbon simultaneously inserts into the palladium metal, and the carbon-insertion-type palladium metal having a desired amount of inserted carbon is obtained. The carbon-insertion-type palladium metal is appropriately cleaned with the solvent, and separated from the solvent by solid-liquid separation means such as centrifugal separation and filtration. The separated carbon-insertion-type palladium metal is appropriately dried.

The palladium catalyst of the present invention contains the above-described carbon-insertion-type palladium metal, may also contain the carbon-insertion-type palladium metal itself (unsupported-type palladium catalyst), and may further contain a supported-type palladium catalyst supported by activated carbon, and the like. When the supported-ype palladium catalyst is prepared, it is possible to use a method for allowing a support such as activated carbon to exist in the above-described palladium compound solution, a method for preparing the carbon-insertion-type palladium metal and thereafter allowing the a support such as activated carbon to support the metal, and the like.

The palladium catalyst of the present invention contains the above-described carbon-insertion-type palladium metal. The amount of inserted carbon in the carbon-insertion-type palladium metal contained in the palladium catalyst is usually 0.16 mol or more, preferably 0.19 mol or more, more preferably 0.22 mol or more, especially preferably 0.25 mol or more with respect to 1.0 mol of the palladium metal. The amount of inserted carbon is preferably 0.81 mol or less, more preferably 0.78 mol or less, especially preferably 0.75 mol or less.

The palladium catalyst may substantially contain a palladium metal into which carbon does not insert. At this time, assuming that a total amount of the carbon-insertion-type palladium metal contained in the palladium catalyst and the palladium metal into which carbon does not substantially insert is 100 parts by weight, 30 parts or more by weight of the carbon-insertion-type palladium metal are preferable.

The palladium catalyst is appropriately cleaned with the solvent, and is separated from the solvent by solid-liquid separation means such as centrifugal separation and filtration. The separated palladium catalyst is appropriately dried.

The palladium catalyst of the present invention is obtained in this manner.

The palladium catalyst of the present invention may preferably be used as a catalyst in a reaction in which an olefin or α,β-unsaturated aldehyde is oxidized with molecular oxygen in a liquid phase to prepare an α,β-unsaturated carboxylic acid (hereinafter referred to also as liquid-phase oxidation):

The palladium catalyst may also be treated to be activated beforehand. A method of activation is not especially limited, and, for example, a method in which the catalyst is heated under a reducing atmosphere in a hydrogen flow is general.

Next, a preparation method of an α,β-unsaturated carboxylic acid by the use of the palladium catalyst of the present invention will be described. In the preparation method of the α,β-unsaturated carboxylic acid, a reaction in which an olefin or α,β-unsaturated aldehyde that is a raw material is preferably oxidized with molecular oxygen in the liquid phase to prepare the α,β-unsaturated carboxylic acid is carried out in the presence of the palladium catalyst of the present invention. In accordance with this method, the α,β-unsaturated carboxylic acid can be prepared with a high yield.

The examples of the olefin include propylene, isobutylene, 1-butene, 2-butene, and the like. The examples of the α,β-unsaturated aldehyde include acrolein, methacrolein, crotonaldehyde α,β-methyl acrolein), cinnam aldehyde (β-phenyl acrolein), and the like.

When the raw material is the olefin, the α,β-unsaturated carboxylic acid to be prepared is an α,β-unsaturated carboxylic acid including the same carbon skeleton as that of the olefin. When the raw materia is α,β-unsaturated aldehyde, an aldehyde group of the α,β-unsaturated aldehyde is changed to a carboxyl group in the α,β-unsaturated carboxylic acid. Concretely, when the raw material is propylene or acrolein, acrylic acid is obtained. When the raw material is isobutylene or methacrolein, methacrylic acid is obtained.

The palladium catalyst of the present invention is especially suitable for liquid-phase oxidation in which acrylic acid is prepared from propylene or acrolein, or methacrylic acid is prepared from isobutylene or methacrolein.

The olefin or α,β-unsaturated aldehyde which is the raw material may contain a small amount of saturated hydrocarbons and/or lower saturated aldehydes as impurities.

A source of molecular oxygen for use in the liquid-phase oxidation reaction is economically preferably air, but pure oxygen or a mixed gas of pure oxygen and air may also be used. If necessary, it is also possible to use a mixed gas obtained by dilution of air or pure oxygen with nitrogen, carbon dioxide, steam, and the like. A gas such as air is usually introduced to a reactor such as an autoclave in a pressurized state.

The solvent for use in the liquid-phase oxidation is not especially limited, and it is possible to use water; alcohols; ketones; organic acids; organic acid esters; hydrocarbons; and the like. The examples of alcohols include tertiary butanol, cyclohexanol, and the like. The examples of ketones include acetone, methyl ethyl ketone, methyl isobutyl ketone, and the like. The examples of organic acids include acetic acid, propionic acid, n-butyric acid, iso-butyric acid, n-valeric acid, iso-valeric acid, and the like. The examples of organic acid esters include ethyl acetate, methyl propionate, and the like. The examples of the hydrocarbons include hexane, cyclohexane, toluene, and the like. As the solvent for use in the liquid-phase oxidation, organic acids having 2 to 6 carbon atoms, ketones having 3 to 6 carbon atoms, and tertiary butanol are preferable, and acetic acid, and n-valeric acid are especially preferable. One of solvent, or a mixed solvent of two or more solvents may also be used. When at least one selected from a group consisting of alcohols, ketones, organic acids, and organic acid esters, a mixed solvent with water is preferable. The amount of water in the mixed solvent is not especially limited, but the lower limit is preferably 2 wt % or more, more preferably 5 wt % or more with respect to the mass of the mixed solvent. The upper limit of the amount of water is preferably 70 wt % or less, more preferably 50 wt % or less. The mixed solvent preferably has a homogeneous state, but may also have a heterogeneous state.

The liquid-phase oxidation reaction may also be carried out in any of a continuous system and batch system, and the continuous system is preferable in consideration of productivity.

The amount of the olefin or α,β-unsaturated aldehyde in a reaction solution in which the liquid-phase oxidation is carried out is usually 0.1 part by weight or more, preferably 0.5 part by weight or more with respect to 100 parts by weight of the solvent. The upper limit of the usage of the raw material is usually 80 parts by weight or less, preferably 70 parts by weight or less.

The amount of molecular oxygen is usually 0.1 mol or more, preferably 0.3 mol or more, more preferably 0.5 mol or more with respect to 1 mol of the olefin or α,β-unsaturated aldehyde. The upper limit of the molecular oxygen usage is usually 30 mol or less, preferably 25 mol or less, more preferably 20 mol or less.

The palladium catalyst is usually used in a suspended state in the reaction solution in which the liquid-phase oxidation is carried out, and may also be used in a fixed bed. The amount of the palladium catalyst in the reaction solution is usually 0.01 part by weight or more, preferably 0.2 part by weight or more as the palladium catalyst existing in a reaction unit with respect to 100 parts by weight of the solution existing in the reaction unit in which the liquid-phase oxidation is carried out. The upper limit of the amount of the catalyst is usually 60 parts by weight or less, more preferably 50 parts by weight or less.

The temperature and pressure for carrying out the liquid-phase oxidation are appropriately selected depending on the solvent and raw material for use. The lower limit of the reaction temperature is usually 60° C. or more, preferably 70° C. or more, and the upper limit is usually 200° C. or less, preferably 150° C. or less. The lower limit of the reaction pressure is usually 0.5 MPa (gauge pressure) or more, preferably 2 MPa (gauge pressure) or more. The upper limit is usually 10 MPa (gauge pressure) or less, preferably 7 MPa (gauge pressure) or less.

A reason why the α,β-unsaturated carboxylic acid can be prepared with the high yield by the use of the palladium catalyst of the present invention is not clear, but supposedly scattering properties of the palladium catalyst in the reaction solution in which the liquid-phase oxidation is carried out are enhanced by the use of the carbon-insertion-type palladium metal having the desired amount of inserted carbon.

### EXAMPLES

The present invention will hereinafter be described more concretely with examples and comparative examples, but the present invention is not limited to the examples. In the following examples and comparative examples, “parts” mean “parts by weight”.

(Analysis of Raw Material and Products)

Raw materials and products were analyzed by gas chromatography. Conversion of an olefin or α,β-unsaturated aldehyde, selectivity of the α,β-unsaturated aldehyde, selectivity of a polymer/oligomer, and selectivity and yield of an α,β-unsaturated carboxylic acid are defined as follows:
Conversion (%) of the olefin or α,β-unsaturated aldehyde=(B/A)×100;
Selectivity (%) of the α,β-unsaturated aldehyde=(C/B)×100;
Selectivity (%) of the α,β-unsaturated carboxylic acid=(D/B)×100;
Selectivity (%) of the polymer/oligomer=(E/B)×100; and
Yield (%) of the α,β-unsaturated carboxylic acid=(D/A)×100,
where A denotes a mol number of the supplied olefin or α,β-unsaturated aldehyde, B denotes a mol number of the reacted olefin or α,β-unsaturated aldehyde, C denotes a mol number of the prepared α,β-unsaturated aldehyde, D denotes a mol number of the prepared α,β-unsaturated carboxylic acid, and E denotes a mol number of the polymer and oligomer, which is the mol number of the olefin or α,β-unsaturated aldehyde unit, in which a total weight (unit: g) of the prepared polymer and oligomer is divided by a molecular weight of the supplied olefin or α,β-unsaturated aldehyde. Here, in the oxidation reaction of the α,β-unsaturated aldehyde, C/B=0.

(Measurement of Chlorine Content)

The chlorine content was obtained by quantitative determination of chlorine in the palladium compound by an ion chromatography process by AQ2211 (trade name) made by Dionex Co. (column; AS-12A, flow rate; 1.5 ml/min).

(Measurement of Amount of Inserted Carbon)

The amount of inserted carbon was determined by the quantitative determination of carbon in the carbon-insertion-type palladium metal by elemental analysis by VarioELIII (trade name) made by Elemental Co.

(Calculation of Crystal Face Distance measured by XRD)

The X-ray diffraction analysis (XRD) (X ray; Cu-Kα40 kV/100 mA, scan speed; 4°/min) was carried out by RU-200A (trade name) made by Rigaku International Co., and the obtained diffraction angle was assigned to Bragg's condition equation to calculate the crystal face distance of the (111) face of the palladium metal.

### Example 1

(Preparation of Carbon-Insertion-Type Palladium Metal)

1.1 parts of palladium acetate (chlorine content of 62 ppm, made by Aldrich Co.) were added as the palladium compound to 62.0 parts of a 92 wt % aqueous n-valeric acid solution as the solvent, and were heated and dissolved at 80° C. The obtained solution was left to stand at the room temperature, and brought and sealed in an autoclave having a stirring device. A rotation number was set to 1200 rpm, the stirring was started, and introduction and discharge of a nitrogen gas were repeated several times to replace the inside of the autoclave with nitrogen. Thereafter, a propylene gas was introduced at 0.6 MPa (gauge pressure), and the temperature was raised to 50° C. by a heater and held for one hour.

Thereafter, the autoclave was cooled to 20° C. by an ice bath, the gas in the autoclave was discharged, and subsequently the autoclave was opened. The reaction solution in the autoclave was transferred into a centrifugation tube, the carbon-insertion-type palladium metal was precipitated by centrifugal separation, and subsequently a supernatant liquid was removed. An 80 wt % aqueous acetic acid solution was added, the centrifugal separation and the removing of the supernatant liquid were repeated three times to clean the carbon-insertion-type palladium metal, and a black carbon-insertion-type palladium metal was obtained. The amount of inserted carbon in the obtained carbon-insertion-type palladium metal was 0.31 mol with respect to 1.0 mol of the palladium metal, and the crystal face distance of the (111) face of the palladium metal calculated from the diffraction angle measured by the XRD was 2.282 Å (2θ=39.46°). It is to be noted that the obtained XRD chart is shown in FIG. 1.

(Performance Evaluation of Palladium Catalyst)

In the autoclave having the stirring device, 150 parts of the 80 wt % aqueous acetic acid solution containing 200 ppm of p-methoxy phenol were laid as the solvent of the liquid-phase oxidation, and 0.5 part of the carbon-insertion-type palladium metal was scattered as the palladium catalyst.

Furthermore, 5.0 parts of methacrolein were added as the raw material for the liquid-phase oxidation. After hermetically closing the autoclave, the stirring was started at a stirring rotation number of 400 rpm, and the autoclave was heated up to 90° C. by the heater. When the temperature reached 90° C., air was introduced to 3.5 MPa (gauge pressure), the stirring rotation number was increased to 1000 rpm, and this state was held for 40 minutes to carry out the liquid-phase oxidation reaction.

After the end of the reaction, the autoclave was cooled to 20° C. by the ice bath. An absorption bottle containing cold water and a gas trap bag were attached to a gas outlet of the autoclave in this order. The gas outlet of the autoclave was opened to collect the gas, and the pressure in the autoclave was released. The reaction solution in the autoclave was transferred into the centrifugal tube, and the palladium catalyst was precipitated by the centrifugal separation. The supernatant liquid was collected through a membrane filter of PTFE (hole diameter: 0.5 μm).

As a result, the methacrolein conversion was 83.5%, the selectivity of methacrylic acid was 76.8%, the selectivity of the polymer/oligomer was 5.3%, and the yield of methacrylic acid was 64.1%.

### Example 2

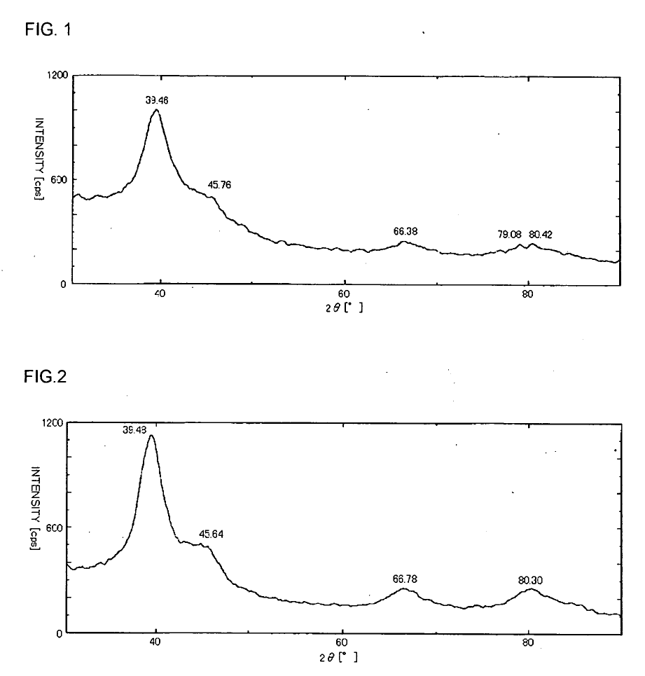

A carbon-insertion-type palladium metal was prepared in the same manner as in Example 1 except that 1.0 part of palladium acetate (chlorine content 80 ppm, made by Tanaka Kikinzoku Kogyo K.K.) was used as a palladium compound and 150 parts of a 93 wt % aqueous n-valeric acid solution were used as a solvent. The amount of inserted carbon in the obtained carbon-insertion-type palladium metal was 0.32 mol with respect to 1.0 mol of the palladium metal, and the crystal face distance of the (111) face of the palladium metal calculated from the diffraction angle measured by the XRD was 2.281 Å (2θ=39.48°). It is to be noted that the obtained XRD chart is shown in FIG. 2.

A performance of a palladium catalyst was evaluated in the same manner as in Example 1 except that the carbon-insertion-type palladium metal was used as the palladium catalyst. As a result, the methacrolein conversion was 86.4%, the selectivity of methacrylic acid was 72.5%, the selectivity of the polymer/oligomer was 8.0%, and the yield of methacrylic acid was 62.6%.

### Example 3

The carbon-insertion-type palladium metal prepared by the procedure of Example 1 was scattered in 50 parts of an 85 wt % aqueous acetic acid solution, and further 5.0 parts of activated carbon (specific surface area; 840 m²/g, pore volume; 0.42 cc/g, average pore diameter; 2.0 nm) were added and stirred at 20° C. for one hour. The obtained dispersion was filtered with suction under a nitrogen flow to obtain an activated carbon-supported palladium catalyst. A palladium loading ratio of the activated carbon-supported palladium catalyst was 10 wt %.

The performance of the palladium catalyst was evaluated in the same manner as in Example 1 except that 5.5 parts by weight of the activated carbon-supported palladium catalyst were used as the palladium catalyst, and 150 parts of a 75 wt % aqueous acetic acid solution containing 200 ppm of p-methoxy phenol were used as the solvent of the liquid-phase oxidation. As a result, the methacrolein conversion was 85.3%, the selectivity of methacrylic acid was 75.2%, the selectivity of the polymer/oligomer was 6.5%, and the yield of methacrylic acid was 64.1%.

### Example 4

A performance of a palladium catalyst was evaluated in the same manner as in Example 1 by the use of the carbon-insertion-type palladium metal prepared in the procedure of Example 1 except that 150 parts of a 70 wt % tertiary butanol containing 200 ppm of p-methoxy quinone were used as the solvent of the liquid-phase oxidation, 6.5 parts of liquefied isobutylene were used as the raw material for the liquid-phase oxidation, and an oxygen/nitrogen mixed gas containing 40 vol % of oxygen was introduced to 3.5 MPa (gauge pressure) after introducing nitrogen to 0.6 MPa (gauge pressure) instead of introducing air to 3.5 MPa (gauge pressure). As a result, the isobutylene conversion was 43.5%, the selectivity of methacrolein was 37.9%, the selectivity of methacrylic acid was 8.6%, the selectivity of the polymer/oligomer was 15.8%, and the yield of methacrylic acid was 3.7%.

### Comparative Example 1

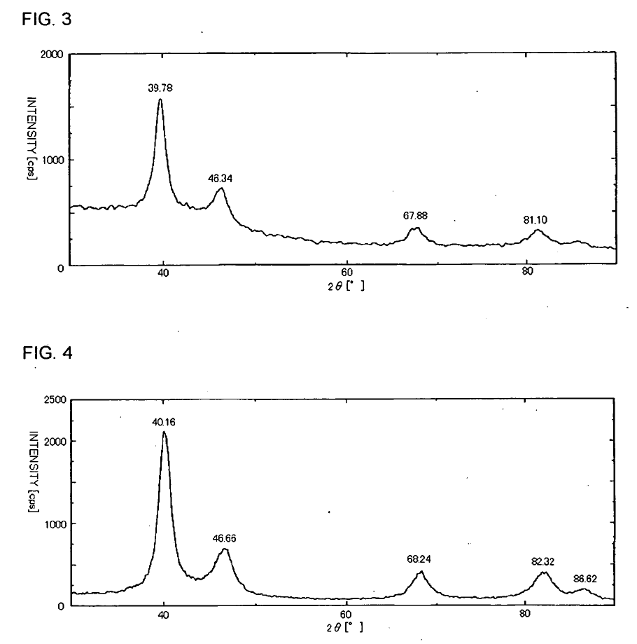

The preparation was carried out in the same manner as in the preparation method of the carbon-insertion-type palladium metal of Example 1 except that 1.0 part of palladium acetate (chlorine content 480 ppm, made by PMC Co.) was used as the palladium compound, and 150 parts of a 90 wt % aqueous n-valeric acid solution were used as the solvent. The amount of inserted carbon in the obtained palladium metal was 0.07 mol with respect to 1.0 mol of the palladium metal. The crystal face distance of the (111) face of palladium calculated from the diffraction angle measured by the XRD was 2.264 Å (2θ=39.78°). It is to be noted that the obtained XRD chart is shown in FIG. 3.

A performance of a palladium catalyst was evaluated in the same manner as in Example 1 except that the palladium metal was used as the palladium catalyst. As a result, the methacrolein conversion was 71.3%, the selectivity of methacrylic acid was 48.0%, the selectivity of the polymer/oligomer was 21.5%, and the yield of methacrylic acid was 34.2%.

### Comparative Example 2

The preparation was carried out in the same manner as in the preparation method of the carbon-insertion-type palladium metal of Example 1 except that 1.0 part of palladium acetate (chlorine content 1100 ppm, made by N.E.CHEMCAT Co.) was used as the palladium compound, and 150 parts of a 93 wt % aqueous n-valeric acid solution were used as the solvent. The amount of inserted carbon in the obtained palladium metal was substantially 0, and the carbon insertion was not observed. The crystal face distance of the (111) face of palladium calculated from the diffraction angle measured by the XRD was 2.244 Å (2θ=40.16°). It is to be noted that the obtained XRD chart is shown in FIG. 4.

A performance of a palladium catalyst was evaluated in the same manner as in Example 1 except that the palladium metal was used as the palladium catalyst. As a result, the methacrolein conversion was 32.9%, the selectivity of methacrylic acid was 42.8%, the selectivity of the polymer/oligomer was 36.0%, and the yield of methacrylic acid was 14.1 %.

### Comparative Example 3

An activated carbon-supported palladium catalyst was obtained in the same manner as in Example 3 by the use of the palladium metal prepared in the procedure of Comparative Example 1. The performance was evaluated in the same manner as in Example 1 except that 150 parts of a 75% aqueous acetic acid solution used as a reaction solvent. As a result, the methacrolein conversion was 72.5%, the selectivity of methacrylic acid was 46.0%, the selectivity of the polymer/oligomer was 22.2%, and the yield of methacrylic acid was 33.4%.

### Comparative Example 4

A performance of a palladium catalyst was evaluated in the same manner as in Example 4 except that the palladium metal of Comparative Example 1 was used as the palladium catalyst, and air was introduced to 3.5 MPa (gauge pressure) after introducing nitrogen to 0.6 MPa (gauge pressure). As a result, the isobutylene conversion was 23.6%, the selectivity of methacrolein was 10.2%, the selectivity of methacrylic acid was 2.5%, the selectivity of the polymer/oligomer was 54.7%, and the yield of methacrylic acid was 0.6%.

The above-described results are shown in Tables 1 and 2.

TABLE 1

| | Amount of | Conversion | Selectivity of | Selectivity | Yield of |
|---|---|---|---|---|---|
| | inserted carbon | of metha- | methacrylic | of polymer/ | methacrylic |
| | (C/Pd) | crolein (%) | acid (%) | oligomer (%) | acid (%) |
| Ex. 1 | 0.31 | 83.5 | 76.8 | 5.3 | 64.1 |
| Ex. 2 | 0.32 | 86.4 | 72.5 | 8.0 | 62.6 |
| Ex. 3 | 0.31 | 85.3 | 75.2 | 6.5 | 64.1 |
| Comp. Ex. 1 | 0.07 | 71.3 | 48.0 | 21.5 | 34.2 |
| Comp. Ex. 2 | 0 | 32.9 | 42.8 | 36.0 | 14.1 |
| Comp. Ex. 3 | 0.07 | 72.5 | 46.0 | 22.2 | 33.4 |

TABLE 2

| | Amount of | Conversion of | Selectivity of | Selectivity of | Selectivity | Yield of |
|---|---|---|---|---|---|---|
| | inserted carbon | isobutylene | methacrolein | methacrylic | of polymer/ | methacrylic |
| | (C/Pd) | (%) | (%) | acid (%) | oligomer (%) | acid (%) |
| Ex. 4 | 0.31 | 43.5 | 37.9 | 8.6 | 15.8 | 3.7 |
| Comp. Ex. 4 | 0.07 | 23.6 | 10.2 | 2.5 | 54.7 | 0.6 |

In this manner, it has been revealed that an α,β-unsaturated carboxylic acid can be prepared with a high yield by the liquid-phase oxidation of an olefin or α,β-unsaturated aldehyde using the palladium catalyst containing the carbon-insertion-type palladium metal of the present invention.

### INDUSTRIAL APPLICABILITY

A palladium catalyst containing a carbon-insertion-type palladium metal of the present invention is high in catalyst activity for use in a reaction in which, for example, an olefin or α,β-unsaturated aldehyde is oxidized to obtain an α,β-unsaturated carboxylic acid in a liquid phase, and the α,β-unsaturated carboxylic acid can be manufactured with a high yield by the use of the palladium catalyst.

1-13. (canceled)

14: A carbon-insertion-type palladium metal wherein an amount of inserted carbon is 0.16 mol or more with respect to 1.0 mol of a palladium metal.

15: A carbon-insertion-type palladium metal wherein a crystal face distance of a (111) face of a palladium metal calculated from a diffraction angle measured by an X-ray diffraction analysis is 2.270 Å or more.

16: A palladium catalyst comprising the carbon-insertion-type palladium metal according to claim 14.

17: The palladium catalyst according to claim 16, wherein said palladium catalyst is utilized for the preparation of an α,β-unsaturated carboxylic acid.

18: A palladium catalyst comprising the carbon-insertion-type palladium metal according to claim 15.

19: The palladium catalyst according to claim 18, wherein said palladium catalyst is utilized for the preparation of an α,β-unsaturated carboxylic acid.

20: A method for the preparation of a carbon-insertion-type palladium metal, comprising a step of reducing palladium in a palladium compound in a palladium compound solution in which the palladium compound having a chlorine content of 0 to 300 ppm is dissolved in a solvent.

21: The method for the preparation of a carbon-insertion-type palladium metal according to claim 20, wherein the step is performed at −5 to 150° C.

22: The method for the preparation of a carbon-insertion-type palladium metal according to claim 20, wherein the solvent is an organic solvent or a mixed solvent of water and an organic solvent.

23: The method for the preparation of a carbon-insertion-type palladium metal according to claim 22, wherein the organic solvent contains at least one selected from the group consisting of carboxylic acids, ketones, and alcohols.

24: The method for the preparation of a carbon-insertion-type palladium metal according to claim 20, wherein the reduction step is performed by a reducing agent.

25: The method for the preparation of a carbon-insertion-type palladium metal according to claim 24, wherein the reducing agent is an olefin having 2 to 6 carbon atoms.

26: The method for the preparation of a carbon-insertion-type palladium metal according to claim 20, wherein an amount of inserted carbon is 0.16 mol or more with respect to 1.0 mol of a palladium metal.

27: The method for the preparation of a carbon-insertion-type palladium metal according to claim 20, wherein a crystal face distance of a (111) face of a palladium metal calculated from a diffraction angle measured by an X-ray diffraction analysis is 2.270 Å or more.

28: A method for the preparation of a palladium catalyst comprising preparing a carbon-insertion-type palladium metal according to the method of claim 20.

29: A method for the preparation of a palladium catalyst comprising preparing a carbon-insertion-type palladium metal according to the method of claim 26.

30: A method for the preparation of a palladium catalyst comprising preparing a carbon-insertion-type palladium metal according to the method of claim 27.

31: A method for the preparation of an α,β-unsaturated carboxylic acid in which an oxidation reaction of an olefin or an α,β-unsaturated aldehyde with molecular oxygen in a liquid phase to prepare the α,β-unsaturated carboxylic acid is performed in the presence of the palladium catalyst according to claim 17.

32: A method for the preparation of an α,β-unsaturated carboxylic acid in which an oxidation reaction of an olefin or an α,β-unsaturated aldehyde with molecular oxygen in a liquid phase to prepare the α,β-unsaturated carboxylic acid is performed in the presence of the palladium catalyst according to claim 19.
